(19) United States
(12) Patent Application Publication
(10) Pub. No.: US 2025/0087197 A1
(43) Pub. Date: Mar. 13, 2025

(54) CANCELLATION APPARATUS, METHOD AND PROGRAM

(71) Applicant: NIPPON TELEGRAPH AND TELEPHONE CORPORATION, Tokyo (JP)

(72) Inventors: Hiroaki ITO, Tokyo (JP); Yohei WAKISAKA, Tokyo (JP); Noriyoshi KAMADO, Tokyo (JP); Shin MURATA, Tokyo (JP)

(73) Assignee: NIPPON TELEGRAPH AND TELEPHONE CORPORATION, Tokyo (JP)

(21) Appl. No.: 18/721,654

(22) PCT Filed: Dec. 24, 2021
(86) PCT No.: PCT/JP2021/048169

§ 371 Date: Jun. 18, 2024

(51) Int. Cl. G10K 11/178

(52) U.S. Cl. CPC G10K 11/17823; G10K 11/17825; G10K 11/17881; G10K 2210/3026; G10K 2210/3027

(57) ABSTRACT

A cancellation device includes: a first AD conversion unit 2 that converts a noise signal into a digital signal; a second AD conversion unit 4 that converts an error signal obtained by an error microphone arranged in a region in which noise is to be suppressed into a digital signal; a sound signal processing unit 5 that generates a cancellation signal for suppressing the noise on the basis of the digital signal of the noise and the digital signal of the error signal; a DA conversion unit 6 that converts the cancellation signal into an analog signal and causes a cancellation speaker to emit sound based on the analog signal of the cancellation signal; and an internal parameter control unit 8 that dynamically controls an internal parameter to be used in AD conversion or DA conversion according to a statistical feature of the noise.

### TECHNICAL FIELD

The present invention relates to a technology for suppressing noise.

### BACKGROUND ART

Active noise control is known as a technology of suppressing noise.

FIG. 4 illustrates an example of a configuration of a conventional active noise control device.

A conventional configuration includes a reference microphone P1 that acquires noise, an ANC processing unit P2 that generates cancellation sound for canceling the noise acquired by the reference microphone P1, a cancellation speaker P3 that outputs the cancellation sound, and an error microphone P4 that detects uncanceled noise and actively adjusts the cancellation sound.

The error microphone P4 is arranged in a region PR where noise is desired to be suppressed.

### CITATION LIST

### Non Patent Literature

Non Patent Literature 1: Kajikawa, “Active noise control no saikin no wadai to ouyou (in Japanese) (Recent Topics and Applications of Active Noise Control)”, Research Report Music Information Science (MUS), vol. 2015-MUS-107, no. 3, pp. 1-6, May 2015.

### SUMMARY OF INVENTION

### Technical Problem

As described above, the ANC processing unit P2 determines the sound to be output from the cancellation speaker P3 as the secondary sound source on the basis of the noise signal acquired by the reference microphone P1 and the suppression error input to the error microphone, and the sound is output so as to cancel each other with the noise at the point of the error microphone P4.

Here, the performance of the ANC changes depending on the magnitude of the delay of the AD converter (ADC) connected to the reference microphone P1 and the error microphone P4 and the magnitude of the delay of the DA converter (DAC) connected to the cancellation speaker P3.

Therefore, in order to enhance the noise suppression performance, it is preferable to appropriately change internal parameters to be used in conversion of a digital signal or an analog signal, such as a delay, according to a use scene of active noise control.

However, there has been no technology of appropriately changing the internal parameters according to the use scene of the active noise control.

An object of the present invention is to provide a cancellation device, a method, and a program having higher noise suppression performance than conventional ones.

### Solution to Problem

A cancellation device according to one aspect of the present invention includes: a first AD conversion unit that converts a noise signal, which is a signal of noise acquired by a reference microphone for acquiring noise, into a digital signal; a second AD conversion unit that converts an error signal obtained by an error microphone arranged in a region in which noise is to be suppressed into a digital signal; a sound signal processing unit that generates a cancellation signal for suppressing the noise on the basis of the digital signal of the noise and the digital signal of the error signal; a DA conversion unit that converts the cancellation signal into an analog signal and causes a cancellation speaker to emit sound based on the analog signal of the cancellation signal; and an internal parameter control unit that dynamically controls an internal parameter to be used in AD conversion or DA conversion in the first AD conversion unit, the second AD conversion unit, and the DA conversion unit according to a statistical feature of noise.

### Advantageous Effects of Invention

By dynamically controlling internal parameters to be used in conversion of a digital signal or an analog signal according to a statistical feature of noise, noise suppression performance can be enhanced more than that of conventional ones.

### BRIEF DESCRIPTION OF DRAWINGS

FIG. 1 is a diagram illustrating an example of a functional configuration of a cancellation device.

FIG. 2 is a diagram illustrating an example of a processing procedure of a cancellation method.

FIG. 3 is a diagram illustrating a functional configuration example of a computer.

FIG. 4 is a diagram for describing Background Art.

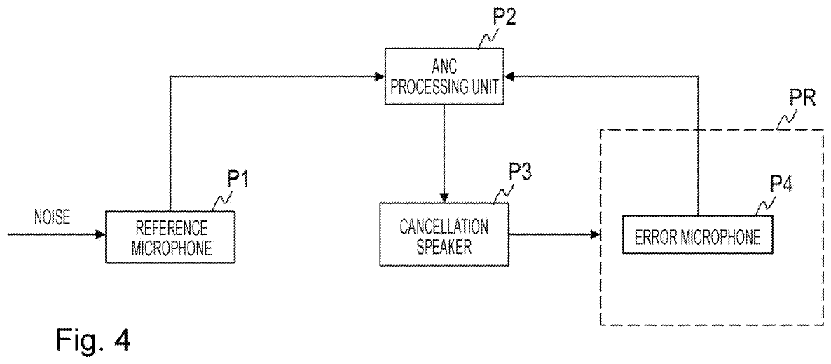

### DESCRIPTION OF EMBODIMENTS

Hereinafter, an embodiment of the present invention will be described in detail. In the drawings, components having the same functions are denoted by the same reference numerals, and redundant description will be omitted.

### [Cancellation Device and Method]

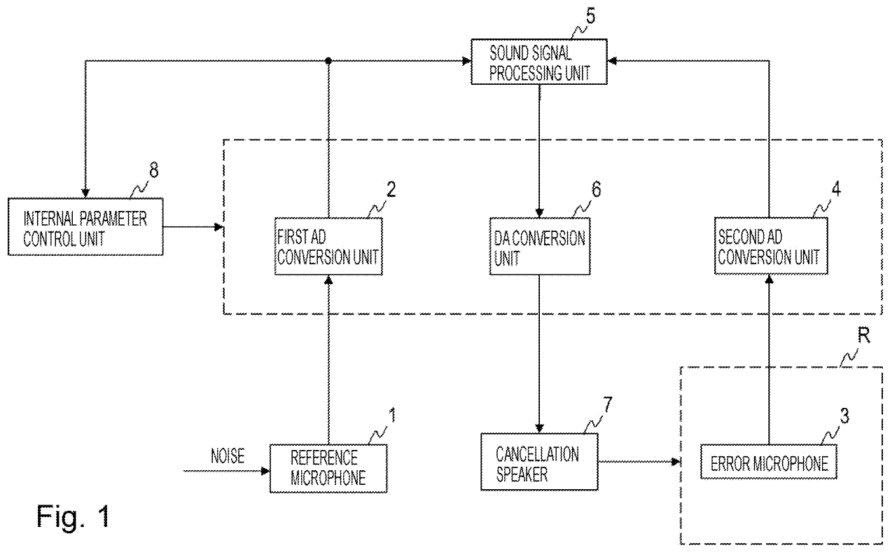

As illustrated in FIG. 1, the cancellation device includes a first AD conversion unit 2, a second AD conversion unit 4, a sound signal processing unit 5, a DA conversion unit 6, and an internal parameter control unit 8. The cancellation device may further include a reference microphone 1, an error microphone 3, and a cancellation speaker 7.

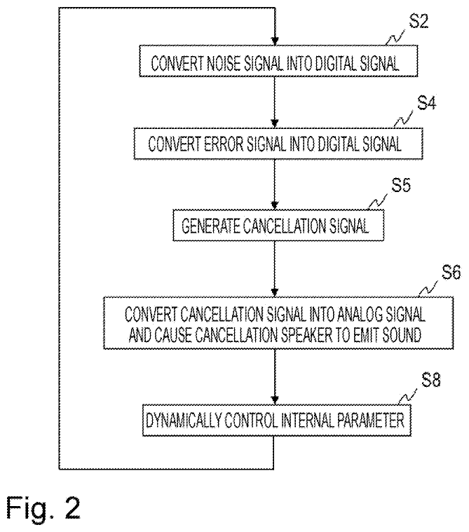

The cancellation method is implemented, for example, by each component of the cancellation device performing processing of step S2 to step S8 which will be described below and is illustrated in FIG. 2.

Each component of the cancellation device will be described below.

### <Reference Microphone 1>

The reference microphone 1 is a microphone for acquiring noise. A noise signal that is a noise signal acquired by the reference microphone 1 is output to the first AD conversion unit 2.

The reference microphone 1 is arranged, for example, near the cancellation speaker 7.

### <First AD Conversion Unit 2>

The noise signal acquired by the reference microphone 1 is input to the first AD conversion unit 2.

The internal parameter determined by the internal parameter control unit 8 is input to the first AD conversion unit 2.

The first AD conversion unit 2 converts a noise signal, which is a signal of noise acquired by a reference microphone for acquiring noise, into a digital signal (step S2). That is, the first AD conversion unit 2 converts a noise signal that is an analog signal into a digital signal.

The digital signal of the noise converted by the first AD conversion unit 2 is output to the sound signal processing unit 5.

The first AD conversion unit 2 performs AD conversion on the basis of the internal parameter determined by the internal parameter control unit 8.

The internal parameter will be described in the description of the internal parameter control unit 8.

### <Error Microphone 3>

The error microphone 3 is a microphone arranged in a region R where noise is desired to be suppressed. The error signal obtained by the error microphone 3 is output to the second AD conversion unit 4.

### <Second AD Conversion Unit 4>

The error signal is input to the second AD conversion unit 4.

The second AD conversion unit 4 converts the error signal obtained by the error microphone arranged in the region where the noise is desired to be suppressed into a digital signal (step S4).

The digital signal of the error signal converted by the second AD conversion unit 4 is output to the sound signal processing unit 5.

The second AD conversion unit 4 performs AD conversion on the basis of the internal parameter determined by the internal parameter control unit 8.

### <Sound Signal Processing Unit 5>

The digital signal of the noise and the digital signal of the error signal are input to the sound signal processing unit 5.

The sound signal processing unit 5 generates a cancellation signal for suppressing noise on the basis of the digital signal of the noise and the digital signal of the error signal (step S5). The cancellation signal is a digital signal. The generated cancellation signal is output to the DA conversion unit 6.

The sound signal processing unit 5 corresponds to the ANC processing unit P2 of the background art.

For example, the sound signal processing unit 5 generates a cancellation signal that is a drive signal for the cancellation speaker 7, for example, using an adaptive algorithm on the basis of the digital signal of the noise and the digital signal of the error signal.

The sound signal processing unit 5 may generate the cancellation signal by another existing method other than the adaptive algorithm.

### <DA Conversion Unit 6>

The cancellation signal is input to the DA conversion unit 6.

The DA conversion unit 6 converts the cancellation signal into an analog signal. The analog signal of the cancellation signal is output to the cancellation speaker 7.

As described later, the cancellation speaker 7 emits a sound on the basis of an analog signal of the cancellation signal. Therefore, it can be said that the DA conversion unit 6 converts the cancellation signal into an analog signal to cause the cancellation speaker 7 to emit a sound based on the analog signal of the cancellation signal (step S6).

The DA conversion unit 6 performs DA conversion on the basis of the internal parameter determined by the internal parameter control unit 8.

### <Cancellation Speaker 7>

The analog signal of the cancellation signal is input to the cancellation speaker 7.

The cancellation speaker 7 emits a sound on the basis of the cancellation signal.

This sound is emitted toward the region R where noise is desired to be suppressed.

### <Internal Parameter Control Unit 8>

The digital signal of the noise converted by the first AD conversion unit 2 is input to the internal parameter control unit 8.

The internal parameter control unit 8 dynamically controls internal parameters to be used in AD conversion or DA conversion in the first AD conversion unit 2, the second AD conversion unit 4, and the DA conversion unit 6 according to a statistical feature of the noise (step S8).

The internal parameter is at least one of a delay amount, time resolution, and frequency resolution. The internal parameter may be another parameter such as an operation clock to be used in AD conversion or DA conversion.

The internal parameter control unit 8 extracts a statistical feature of the noise on the basis of the input digital signal of the noise converted by the first AD conversion unit 2. The internal parameter control unit 8 determines an internal parameter to be used in AD conversion or DA conversion in the first AD conversion unit 2, the second AD conversion unit 4, and the DA conversion unit 6 on the basis of the extracted statistical feature of the noise. The internal parameter control unit 8 outputs the determined internal parameter to be used in AD conversion in the first AD conversion unit 2 to the first AD conversion unit 2. The internal parameter control unit 8 outputs the determined internal parameter to be used in AD conversion in the second AD conversion unit 4 to the second AD conversion unit 4. The internal parameter control unit 8 outputs the determined internal parameter to be used in DA conversion in the DA conversion unit 6 to the DA conversion unit 6. The first AD conversion unit 2, the second AD conversion unit 4, and the DA conversion unit 6 perform AD conversion or DA conversion on the basis of the input internal parameter. The dynamic control by the internal parameter control unit 8 is performed as described above, for example.

Examples of the statistical feature of noise are temporal changes in noise characteristics and noise magnitudes. Of course, other statistical features may be used as the statistical features of the noise.

For example, the internal parameter control unit 8 may determine a smaller delay amount as the temporal change of the noise characteristic is smaller.

The internal parameter control unit 8 may compare the temporal change of the noise characteristic with a predetermined threshold, and determine a small delay amount Ds when the temporal change of the noise characteristic is smaller, and may determine a large delay amount Dl when the temporal change of the noise characteristics is larger.

The delay amounts Ds and Dl are predetermined delay amounts, and Ds<Dl.

The internal parameter control unit 8 may determine a smaller delay amount as the magnitude of the noise is larger.

The internal parameter control unit 8 may compare the magnitude of the noise with a predetermined threshold, determine a small delay amount Ds when the magnitude of the noise is larger, and determine a large delay amount Dl when the magnitude of the noise is smaller.

The internal parameter control unit 8 may control an internal parameter used at the time of AD conversion in the first AD conversion unit 2, an internal parameter used at the time of AD conversion in the second AD conversion unit 4, and an internal parameter used at the time of DA conversion in the DA conversion unit 6 in conjunction with one another.

The internal parameter control unit 8 may determine an internal parameter to be an initial value on the basis of prior information input by the user using an input device such as a keyboard or a mouse.

An example of the prior information input by the user is information of a use scene in which the cancellation device and the method are used.

For example, when the use scene input by the user is a scene with large noise such as a railway, an automobile, or an airplane, the internal parameter control unit 8 determines a small delay amount Ds.

On the other hand, when the use scene input by the user is a scene with moderate noise such as remote work, the internal parameter control unit 8 determines a moderate delay amount Dm.

Ds and Dm are predetermined delay amounts, and Ds<Dm.

As in this example, the internal parameter control unit 8 may determine a smaller delay amount as the assumed noise is larger.

The internal parameter control unit 8 may include a scene decision unit 81. In this case, a digital signal of noise converted by the first AD conversion unit 2 is input to the internal parameter control unit 8.

The scene decision unit 81 of the internal parameter control unit 8 decides the use scene on the basis of the digital signal of the noise. For example, the scene decision unit 81 may decide the use scene by using a learning model learned in advance.

In general, when AD conversion and DA conversion are performed with high time resolution and high frequency resolution in order to improve noise suppression performance, input/output delay increases. If the amount of the delay is too large, it becomes difficult to cause the sound emitted from the cancellation speaker to follow the actual noise, and the suppression performance may be deteriorated.

On the other hand, if the time resolution and the frequency resolution of the AD conversion and the DA conversion are too low in order to reduce the delay, it is difficult to analyze fine noise, and it is not possible to generate a signal that appropriately cancels noise with a small volume or noise with severe time variation, and suppression performance may be deteriorated.

Therefore, in the design of active noise suppression, it is necessary to appropriately handle the trade-off in AD conversion and DA conversion as described above.

As described above, by dynamically controlling the internal parameters to be used in the conversion of the digital signal or the analog signal according to the statistical feature of the noise, for example, the trade-off as described above can be appropriately handled, and the noise suppression performance can be enhanced more than that of conventional ones.

As described above, it is also possible to reduce the power consumption of the ANC system by dynamically controlling the internal parameters.

### [Modification]

While the embodiment of the present invention has been described above, specific configurations are not limited to the embodiment, and it is needless to say that appropriate design changes, and the like are included in the present invention without departing from the gist of the present invention.

The various types of processing described in the embodiment may be performed not only in chronological order in accordance with the described order, but also in parallel or individually depending on the processing capability of a device that performs the processing or as necessary.

For example, data exchange between the components of a cancellation device may be performed directly or via a storage unit (not illustrated).

### [Program and Recording Medium]

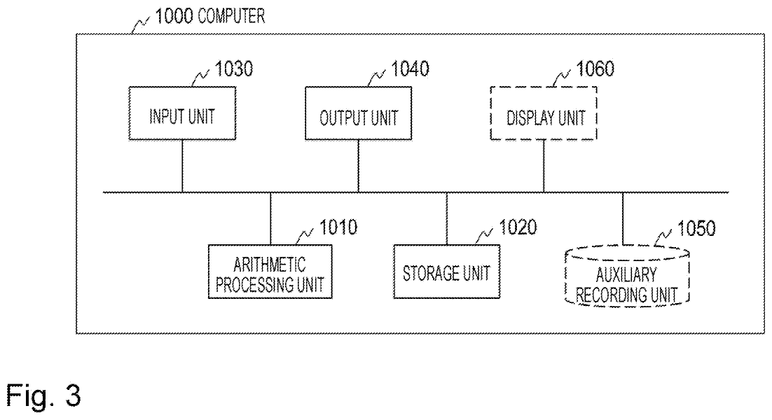

The processing of each unit of each of the devices described above may be implemented by a computer, in which case, processing content of a function that each of the devices should have is described by a program. By causing a storage unit 1020 of a computer 1000 illustrated in FIG. 3 to read this program and causing an arithmetic processing unit 1010, an input unit 1030, an output unit 1040, and the like to execute the program, various processing functions in each of the foregoing devices are implemented on the computer. The computer 1000 may include a display unit 1060.

The program in which the processing content is written may be recorded on a computer-readable recording medium. The computer-readable recording medium is, for example, a non-transitory recording medium and is specifically a magnetic recording device, an optical disc, or the like.

In addition, the program is distributed by, for example, selling, transferring, or renting a portable recording medium such as a DVD or a CD-ROM on which the program is recorded. Further, a configuration may also be employed in which the program is stored in a storage device of a server computer and the program is distributed by transferring the program from the server computer to other computers via a network.

For example, the computer that performs such a program first temporarily stores the program recorded in a portable recording medium or the program transferred from the server computer in an auxiliary recording unit 1050 that is a non-transitory storage device of the computer. Then, at the time of performing processing, the computer reads the program stored in the auxiliary recording unit 1050 that is the non-temporary storage device of the computer into the storage unit 1020 and performs processing in accordance with the read program. In addition, as another embodiment of the program, the computer may directly read the program from the portable recording medium into the storage unit 1020 and perform processing in accordance with the program, and furthermore, the computer may sequentially perform processing in accordance with a received program each time the program is transferred from the server computer to the computer. In addition, the above-described processing may be performed by a so-called application service provider (ASP) type service that implements a processing function only by a performance instruction and result acquisition without transferring the program from the server computer to the computer. Note that the program in the present embodiment includes information that is used for processing by an electronic computer and is equivalent to the program (data or the like that is not a direct command to the computer but has property that defines processing performed by the computer).

In addition, although the present devices are each configured by executing a predetermined program on a computer in the present embodiments, at least part of the processing content may be implemented by hardware. For example, the first AD conversion unit 2, the second AD conversion unit 4, the sound signal processing unit 5, the DA conversion unit 6, and the cancellation speaker 7 may be configured by a processing circuit.

In addition, it is needless to say that modifications can be appropriately made without departing from the gist of the present invention.

1.-4. (canceled)

5. A cancellation device comprising processing circuitry configured to:
convert a noise signal, which is a signal of noise acquired by a reference microphone for acquiring noise, into a digital signal;
convert an error signal obtained by an error microphone arranged in a region in which noise is to be suppressed into a digital signal;
generate a cancellation signal for suppressing the noise based on the digital signal of the noise and the digital signal of the error signal;
convert the cancellation signal into an analog signal and causes a cancellation speaker to emit sound based on the analog signal of the cancellation signal; and
dynamically control an internal parameter to be used in AD conversion or DA conversion by the processing circuitry according to a statistical feature of the noise.

6. The cancellation device according to claim 5,
wherein the internal parameter is at least one of a delay amount, time resolution, and frequency resolution.

7. The cancellation device according to claim 6,
wherein the internal parameter is a delay amount, and
the processing circuitry determines the delay amount that is smaller as a magnitude or temporal change of the noise is larger.

8. The cancellation device according to claim 5,
wherein the processing circuitry determines the internal parameter according to a use scene.

9. A cancellation method comprising:
a first AD conversion step of converting a noise signal, which is a signal of noise acquired by a reference microphone for acquiring noise, into a digital signal;
a second AD conversion step of converting an error signal obtained by an error microphone arranged in a region in which noise is to be suppressed into a digital signal;
a sound signal processing step of generating a cancellation signal for suppressing the noise based on the digital signal of the noise and the digital signal of the error signal;
a DA conversion step of converting the cancellation signal into an analog signal and causing a cancellation speaker to emit sound based on the analog signal of the cancellation signal; and
an internal parameter control step of dynamically controlling an internal parameter to be used in AD conversion or DA conversion in the first AD conversion step, the second AD conversion step, and the DA conversion step according to a statistical feature of the noise.

10. The cancellation method according to claim 9,
wherein the internal parameter is at least one of a delay amount, time resolution, and frequency resolution.

11. The cancellation method according to claim 10,
wherein the internal parameter is a delay amount, and,
in the internal parameter control step, the delay amount that is smaller as a magnitude or temporal change of the noise is larger is determined.

12. The cancellation method according to claim 9,
wherein, in the internal parameter control step, the internal parameter is determined according to a use scene.

13. A non-transitory computer readable medium that stores a program for causing a computer to perform as each step of the cancellation method according to claim 9.
